(19) United States
(12) Patent Application Publication
(10) Pub. No.: US 2024/0311053 A1
(43) Pub. Date: Sep. 19, 2024

(54) MANAGING POWER CONSUMPTION ASSOCIATED WITH COMMUNICATING DATA IN A MEMORY SYSTEM

(71) Applicant: Micron Technology, Inc., Boise, ID (US)

(72) Inventors: Deping He, Boise, ID (US); Jonathan S. Parry, Boise, ID (US)

(21) Appl. No.: 18/595,590

(22) Filed: Mar. 5, 2024

Related U.S. Application Data
(60) Provisional application No. 63/451,969, filed on Mar. 14, 2023.

(51) Int. Cl. G06F 3/06

(52) U.S. Cl. CPC G06F 3/0659; G06F 3/0613; G06F 3/0679

(57) ABSTRACT

Methods, systems, and devices for managing power consumption associated with communicating data in a memory system are described. A memory system may selectively reduce a periodicity of a clock signal for one or more types of write operations, which may improve power consumption associated with data transfer rates during the one or more types of write operations. For example, the memory system may modify the clock signal for triple-level cell (TLC) write operations. The memory system reduce a periodicity of the clock signal to improve performance for TLC write operations by trading communication speed for internal array performance. Additionally, or alternatively, some media management operations performed by the memory system that involve transferring data to higher-density memory cells may trigger the memory system to modify the clock signal.

### CROSS REFERENCE

The present application for patent claims priority to U.S. Patent Application No. 63/451,969 by He et al., entitled “MANAGING POWER CONSUMPTION ASSOCIATED WITH COMMUNICATING DATA IN A MEMORY SYSTEM,” filed Mar. 14, 2023, which is assigned to the assignee hereof, and which is expressly incorporated by reference in its entirety herein.

### TECHNICAL FIELD

The following relates to one or more systems for memory, including managing power consumption associated with communicating data in a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states in response to being disconnected from an external power source.

### BRIEF DESCRIPTION OF THE DRAWINGS

FIG. 1 illustrates an example of a system that supports managing power consumption associated with communicating data in a memory system in accordance with examples as disclosed herein.

FIG. 2 illustrates an example of a clock signal configuration that supports managing power consumption associated with communicating data in a memory system in accordance with examples as disclosed herein.

FIG. 3 illustrates an example of a process flow that supports managing power consumption associated with communicating data in a memory system in accordance with examples as disclosed herein.

FIG. 4 illustrates a block diagram of a memory system that supports managing power consumption associated with communicating data in a memory system in accordance with examples as disclosed herein.

FIG. 5 illustrates a flowchart showing a method or methods that support managing power consumption associated with communicating data in a memory system in accordance with examples as disclosed herein.

### DETAILED DESCRIPTION

Some memory systems may support various rates for data transfer, which, in some cases, may be associated with respective standards or protocols for memory system operation, as well as corresponding channels (e.g., open not-and (NAND) flash interface (ONFI) channels). For example, a first memory system (e.g., a universal flash storage (UFS) 4 memory system) may be capable of transferring data at speeds of up to 4 gigabytes per second (GB/s) and a second memory system (e.g., a UFS 3 memory system) may be capable of transferring data at speeds of up to 2 GB/s. In some cases, a memory system may achieve or may be more likely to achieve a higher (e.g., maximum) data transfer rate if a total power consumption (e.g., for the memory system, for a host system, or both) fails to satisfy (e.g., is below) a power consumption threshold (e.g., for the memory system, for the host system, or both). Additionally, or alternatively, writing data to some types of memory cells, such as triple-level cells (TLCs) may consume more power than writing data to other types of memory cells, such as single-level cells (SLCs). Accordingly, data transfer rates for a memory system may be adversely limited if a total power consumption exceeds a power consumption threshold, which may be caused, at least in part, by write operations for some types of memory cells, such as TLCs. In some cases, such as if a power consumption threshold is exceeded, a memory system may reduce or throttle a data transfer rate (e.g., for TLC write operations) to reduce power consumption or otherwise maintain power consumption to be below a power consumption threshold. However, in such cases, a memory system may not achieve a maximum data transfer rate (e.g., a theoretical maximum for the memory system), which may negatively impact performance of the memory system.

In accordance with examples as described herein, a memory system may modify a clock signal (e.g., an ONFI clock signal) to manage (e.g., reduce, decrease, maintain, adjust, update, modify) power consumption of the memory system, which may enable the memory system to perform data transfer operations at higher rates compared to examples described above. For example, the memory system may halve a quantity of clock cycles, which may conserve power at the memory system. In some cases, the memory system may determine to modify the clock signal for a type of operation (e.g., type of access operation, type of read operation, type of write operation). For example, the memory system may modify the clock signal (e.g., reduce a periodicity of the clock signal) for transferring data over channels (e.g., ONFI channels) between the memory device (NAND device) and the controller (e.g., UFS controller). In some other cases, receiving signaling to exit (e.g., terminate, pause) a high performance mode (e.g., a write booster mode) may trigger the memory system to modify the clock signal. In such cases, exiting the high performance mode may enable (e.g., allow, initiate) TLC write operations at the memory system, and thus modifying the clock signal may reduce the power consumed for the TLC write operations without increasing the latency for performing the TLC write operations. Additionally, or alternatively, some media management operations that involve transferring data to high-density memory cells may trigger the memory system to modify the clock signal.

In addition to applicability in memory systems as described herein, techniques for improved management of power consumption associated with communicating data in a memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by facilitating better management of power consumption associated with communicating data in a memory system, which may decrease processing or latency times, improve response times, decrease power consumption, or otherwise improve performance, among other benefits.

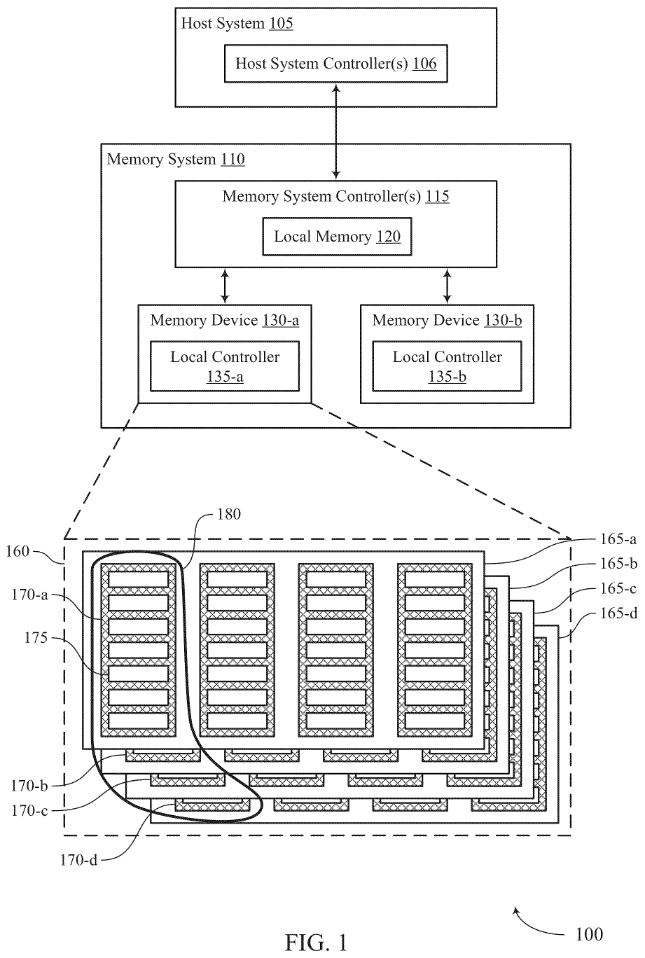

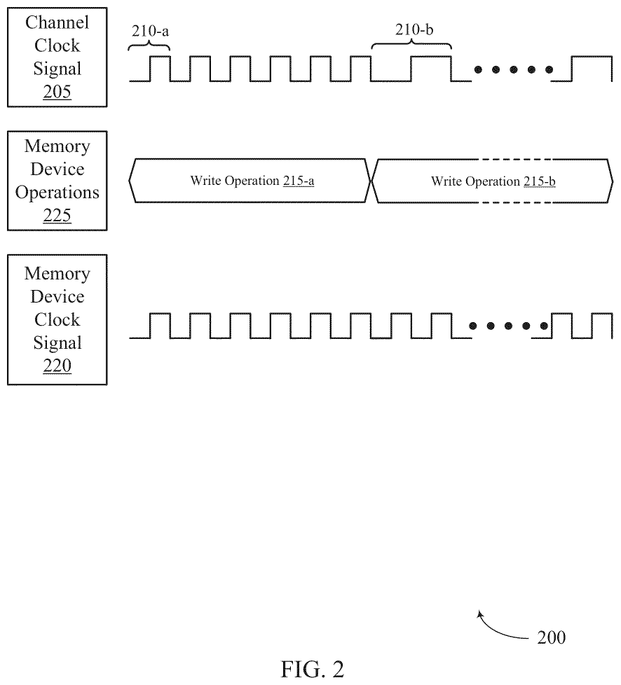

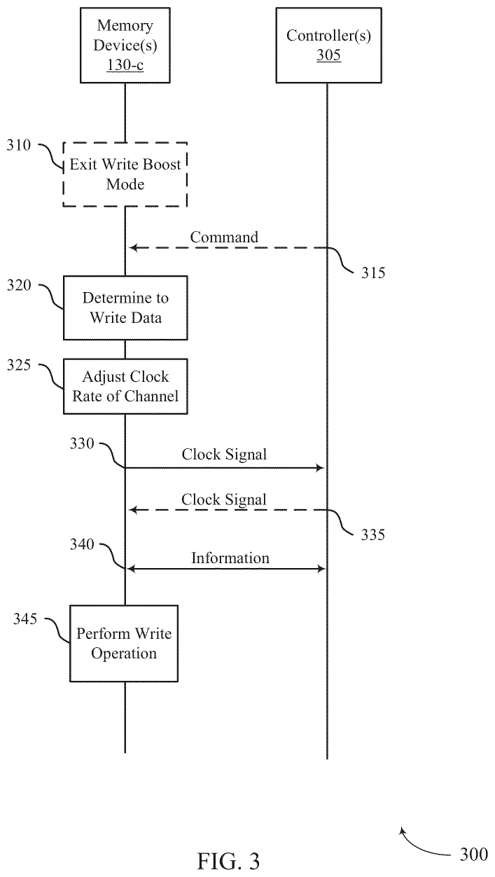

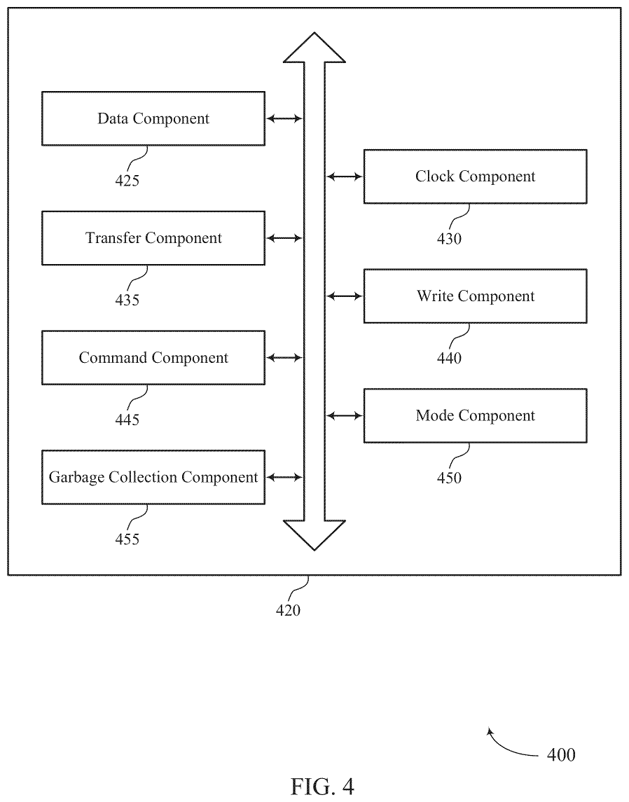

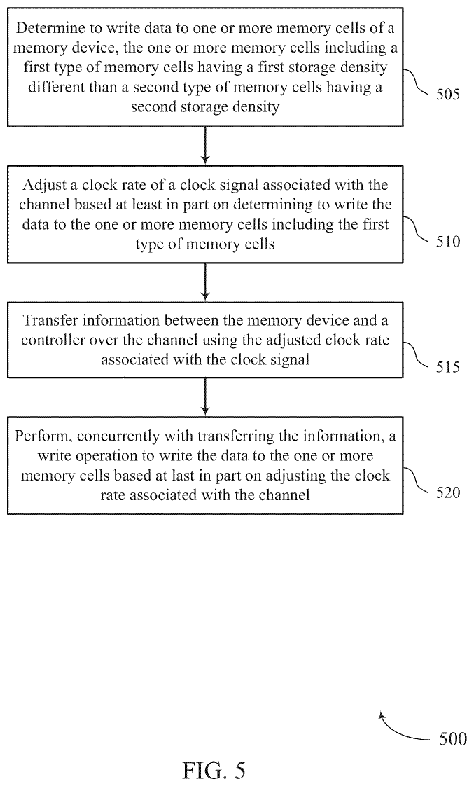

Features of the disclosure are initially described in the context of a system with reference to FIG. 1. Features of the disclosure are described in the context of a clock signal configuration and a process flow with reference to FIGS. 2 through 3. These and other features of the disclosure are further illustrated by and described in the context of an apparatus diagram and flowchart that relate to managing power consumption associated with communicating data in a memory system with reference to FIGS. 4 through 5.

FIG. 1 illustrates an example of a system 100 that supports managing power consumption associated with communicating data in a memory system in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with one or more host system controllers 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include one or more memory system controllers 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller(s) 115 may also include one or more local memories 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as SLCs. Additionally, or alternatively, a NAND memory device 130 may include memory cells configured to each store multiple bits of information, which may be referred to as multi-level cells (MLCs) if configured to each store two bits of information, as TLCs if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support managing (e.g., reducing, decreasing, maintain, adjusting, modifying, updating) power consumption associated with communicating (e.g., writing, storing, receiving, transmitting, outputting, obtaining, transferring) data in a memory system. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

Some memory systems 110 may support various rates for data transfer, which, in some cases, may be associated with respective standards or protocols for memory system 110 operation, as well as corresponding channels (e.g., ONFI channels). For example, a first memory system (e.g., a UFS 4 memory system) may be capable of transferring data at speeds of up to 4 GB/s and a second memory system (e.g., a UFS 3 memory system) may be capable of transferring data at speeds of up to 2 GB/s. In some cases, a memory system 110 may achieve or may be more likely to achieve a maximum data transfer rate if a total power consumption (e.g., for the memory system 110, for a host system 105, or both) fails to satisfy a power consumption threshold (e.g., for the memory system 110, for the host system 105, or both). Additionally, or alternatively, writing data to some types of memory cells, such as TLCs may consume more power than writing data to other types of memory cells, such as SLCs.

Data transfer rates for a memory system 110 may be adversely limited if a total power consumption exceeds a power consumption threshold. For example, power consumption may be capped at a threshold (e.g., 1.2 amps) to ensure that heat is dissipated safely in the memory system 110. In some cases, such as if a power consumption threshold is exceeded, a memory system 110 may decrease or throttle a data transfer rate (e.g., for TLC write operations) to decrease power consumption or otherwise maintain power consumption to be below a power consumption threshold. However, in such cases, a memory system 110 may be unable to achieve a maximum data transfer rate (e.g., a theoretical maximum for the memory system 110), which may negatively impact performance of the memory system 110.

In the example of FIG. 1, a memory system 110 may modify (e.g., adjust, update, reduce) a clock signal (e.g., an ONFI clock) to reduce power consumption of the memory system 110, which may enable the memory system 110 to perform data transfer operations at higher rates (e.g., via one or more ONFI channels). For example, the memory system 110 may halve a quantity of clock cycles associated with the channels (thereby reducing the speed of transferring data between memory system controller 115 and the memory device 130-a in half), which may conserve power at the memory system 110. In some cases, the memory system 110 may determine to modify the clock signal for transferring data associated with a type of operation being performed (e.g., a type of read operation or a type of write operation). For example, the memory system 110 may modify the clock signal (e.g., reduce a periodicity of the clock signal) used to transfer data associated with TLC write operations, MLC write operations, QLC write operations, TLC read operations, MLC read operations, QLC read operations, or any combination thereof. In some other cases, receiving signaling to terminate or pause a high performance mode (e.g., a write booster mode) may trigger the memory system 110 to modify the clock signal. In such cases, terminating or pausing the high performance mode may enable or initiate TLC write operations at the memory system 110, and thus modifying the clock signal may improve the power performance of the memory system 110.

In addition to applicability in memory systems 110 as described herein, techniques for modification of a clock signal to reduce power consumption may be generally implemented to improve the performance (including gaming) of various electronic devices and systems. Some electronic device applications, including gaming and other high-performance applications, may be associated with relatively high processing requirements while also benefitting from relatively quick response times to improve user experience. As such, increasing processing speed, decreasing response times, or otherwise improving the performance electronic devices may be desirable. Implementing the techniques described herein may improve the performance of electronic devices by improving power consumption and adjusting data transfer rates (e.g., for an ONFI channel) based on latency for performing other operations (e.g., TLC write operation in the memory device 130-a), which may improve power consumption, improve response times, or otherwise improve user experience, among other benefits.

FIG. 2 illustrates an example of a clock signal configuration 200 that supports managing power consumption associated with communicating data in a memory system in accordance with examples as disclosed herein. One or more aspects of the clock signal configuration 200 may be implemented by one or more aspects of the system 100. For example, the clock signal configuration 200 may include a clock signal 205 (also referred to as channel clock signal), which may be communicated between a memory device 130 and a memory system controller 115, as described with reference to FIG. 1. As described herein, the clock signal 205 may be communicated (e.g., output) using different periodicities 210 (e.g., frequencies) of the clock signal 205. For example, the clock signal 205 may be communicated using a periodicity 210-a for a duration of a write operation 215-a and a periodicity 210-b for a duration of a write operation 215-b. In some cases, the write operation 215-a may be an example of a first type of write operation, such as an SLC write operation, and the write operation 215-b may be an example of a second type of write operation, such as a TLC write operation.

Some types of memory systems 110 are capable of achieving different data transfer speeds. For example, a first type of memory system 110 (e.g., a UFS4 memory system) may be capable of achieving data transfer speeds that are twice as high as a second type of memory system 110 (e.g., a UFS3 memory system). In some cases, the speed that the memory system 110 is capable of executing commands from the host system 105 may be limited by different aspects of the operation. For example, the total speed may be limited by the duration it takes for the memory device 130-a to access memory cells. In other examples, the total speed may be limited by the duration it takes for the channels (e.g., ONFI channels) to communicate the information between the memory device 130-a and the memory system controller 115.

In some cases, total speed for a memory system 110 may depend on power consumption (e.g., power utilization) of the memory system 110. For example, power consumption may be capped at a threshold (e.g., 1.2 amps) to ensure that heat is dissipated safely in the memory system 110. Additionally, or alternatively, some memory systems 110 may be configured with a power consumption threshold. If power consumption of the memory system 110 satisfies (e.g., is greater than) the power consumption threshold, the memory system 110 may throttle (e.g., reduce, decrease, maintain) performance. As an illustrative example, a power consumption threshold (e.g., for the host system 105, for the memory system 110) may be approximately 1.2 amps (A). In some cases, the power consumption threshold may be based on (e.g., determined in response to) an ability of the memory system 110, the host system 105, or both to dissipate heat.

One or more components of a memory system 110 (e.g., a memory device 130, a memory system controller 115, a local controller 135) may output a clock signal 205 to synchronize communications with other components of the memory system 110 over the channels (e.g., ONFI channels). For example, the memory system controller 115 may transmit a clock signal 205 to the memory device 130 and the memory device 130 may determine a timing for transmitting information to or receiving information from the memory system controller 115. Additionally or alternatively, a memory device 130 may transmit a clock signal 205 to the memory system controller 115 and the memory system controller 115 may determine a timing (e.g., a duration) for transmitting (e.g., transferring, outputting, writing) information to or receiving (e.g., obtaining, reading) information from the memory device 130 based on (e.g., using) the clock signal 205. In some cases, the memory device 130 and the memory system controller 115 may perform one or more operations to synchronize communication timing using one or more clock signals 205.

Some memory systems 110 may be configured to adjust performance (e.g., data transfer rates) or operating parameters if a power consumption threshold (e.g., a maximum power threshold) is satisfied. In some cases, the memory system 110 may determine to manage (e.g., adjust, modify, update) data transfer speeds or adjust other operational parameters prior to the power consumption of the memory system 110 satisfying the power consumption threshold. For example, the memory system 110 may reduce data transfer speeds if the power consumption of the memory system 110 is within a range of the power consumption threshold. In some cases, the power consumption threshold may be based on (e.g., determined by, determined in response to) an amount of available power (e.g., a power budget) supplied to a memory system 110 by a host system 105. In some other cases, the power consumption threshold may be preconfigured at the memory system 110.

In some cases, the memory system 110 may manage (e.g., adjust, modify, update) data transfer speeds or adjust other operational parameters based on total latency for performing the command (e.g., host-issued command or internal-issued command) not being affected by the adjustment or being impacted a small amount. For example, if the memory device 130-a takes 1 millisecond to access the memory cells (e.g., a TLC write), the memory system 110 may increase the data transfer rate across the channels (e.g., ONFI channels) from 200 microseconds to 400 microseconds to reduce the power consumption without little or no impact on the total duration for performing the command. These types of adjustments may be effective because operations performed by the memory device 130-a and the transfer of data over the channels may occur concurrently.

Some types of write operations 215 may consume a relatively high amount of power compared to other types of write operations 215. For example, the write operation 215-b may be an example of a TLC write operation, which may consume more power compared to the write operation 215-a, which may be an example of an SLC write operation. In such cases, the write operation 215-b may consume a larger percentage of the power consumption threshold than the write operation 215-a. Although some examples as described herein may refer to SLC operations and TLC operations, the write operation 215-a may more generally be an example of a first type of write operation and the write operation 215-b may more generally be an example of a second type of write operation different from the first type of write operation.

In addition to power consumption for write operations, transmitting (e.g., outputting) the clock signal 205 may also consume power at the memory system 110. In some cases, the clock signal 205 may contribute to a relatively high percentage of the power consumption threshold. In some cases, multiple types of operations (e.g., data transfer operations) may consume power concurrently, which may increase a percentage of the power consumption threshold being utilized by the memory system 110. For example, a duration of a write operation (e.g., a TLC write operation) and a duration of an ONFI data transfer operation (e.g., outputting the clock signal 205) may overlap or partially overlap. In such cases, the combination of the relatively high power consumed by a write operation (e.g., a TLC write operation) and the relatively high power consumed by outputting the clock signal may cause the memory system 110 to throttle performance, which may be undesirable.

In accordance with examples as described herein, the memory system 110 may modify the clock signal 205 (e.g., for one or more write operations, for one or more read operations) to reduce power consumption of the memory system 110, which may lower the rate of the data transfer operations over the channels (e.g., the ONFI channels). For example, the memory system 110 may output the clock signal 205 with the periodicity 210-a during the write operation 215-a (e.g., an SLC write operation) and output the clock signal 205 with the periodicity 210-b during the write operation 215-b (e.g., a TLC write operation). In such cases, outputting the clock signal 205 with the periodicity 210-b may conserve power at the memory system 110. In some cases, the memory system may output the clock signal 205 with the periodicity 210-a after completing the write operation 215-b (e.g., for a read operation, for a subsequent operation different from the write operation 215-b). In some cases, the memory system 110 may adjust the clock signal 205 (e.g., halve the periodicity 210 of the clock signal 205) in response to an indication (e.g., an indication that the memory system 110 exits a high performance mode). In such cases, exiting the high performance mode may enable or initiate TLC write operations at the memory system 110, and thus modifying the clock signal may improve power consumption at memory system 110 by reducing the speed of transferring data while TLC write operations are being performed. Such a reduction in power consumption may be achieved while minimizing the impact on the duration for performing the operations because the write operations may take considerably more time than data transfers and thus the write operations may be more limiting to the total duration than the data transfer. For example, while the clock signal 205 associated with the channels (e.g., ONFI channels) may be slowed to the periodicity 210-b, the clock signal 220 (also referred to as memory device clock signal) associated with performing the memory device operations 225 may be maintained or minimally affected. Different operations may take different durations. For example, an SLC write operation (e.g., write operation 215-a) may take less time than a TLC write operation (e.g., write operation 215-b). This feature may enable a memory system 110 to reduce the speed of the clock signal 205 (and reduce the speed of data transfer) during a TLC write operation to reduce the power consumption without adversely impacting the total duration for performing operations.

FIG. 3 illustrates an example of a process flow 300 that supports managing power consumption associated with communicating data in a memory system in accordance with examples as disclosed herein. In some cases, the process flow 300 may be implemented by aspects of the system 100. For example, the process flow 300 may include one or more memory devices 130-c, which may be an example of a memory device 130, as described with reference to FIG. 1. The process flow 300 may also include one or more controllers 305, which may be an example of a local controller 135 or a memory system controller 115, as described with reference to FIG. 1. In some cases, the process flow 300 may implement aspects of the clock signal configuration 200. For example, the memory device 130-c and the controller 305 may communicate one or more clock signals 205, as described with reference to FIG. 2. Additionally, or alternatively, the memory device 130-c and the controller 305 may modify a clock signal 205 of a channel (e.g., halve a periodicity of a clock signal 205, reduce a power for a clock signal 205) in response to one or more types of write operations being performed at the memory device 130-c, which may improve peak power consumption without adversely impacting the latency of performing the write operations.

In the following description of the process flow 300, the operations between the memory device 130-c and the controller 305 may be performed in a different order than the order shown. Some operations may also be left out of the process flow 300, or other operations may be added to the process flow 300. Further, although some operations or communications may be shown to occur at different times for discussion purposes, these operations may occur at the same time. Additionally, or alternatively, although the memory device 130-c and the controller 305 are shown performing the operations of process flow 300, any component of the system 100 may perform the operations shown.

Aspects of the process flow 300 may be implemented by a controller, among other components. Additionally or alternatively, aspects of the process flow 300 may be implemented as instructions stored in memory (e.g., firmware stored in a memory coupled with the controller 305). For example, the instructions, if executed by a controller (e.g., the controller 305), may cause the controller to perform the operations of the process flow 300.

At 310, a write boost mode (e.g., for the memory system 110) may be terminated. For example, the memory device 130-c may terminate (e.g., exit) the write boost mode. In some cases, the write boost mode may be terminated in response to an indication (e.g., a command) received by the controller 305. The indication may explicitly indicate to terminate the write boost mode. In some other cases, the indication may indicate performance information and the memory device 130-c may exit the write boost mode in response to the indication of the performance information. In some cases, the write boost mode may be terminated if one or more thresholds is satisfied at the memory device 130-c.

At 315, a command may be received (e.g., a write command, an access command). For example, the memory device 130-c may receive a command to write data to one or more memory cells of the memory system 110. In some cases, the memory device 130-c may receive the command from the controller 305. In some other cases, the command may be received from a host system 105 (not shown). The command may include an indication of data to be written to one or more memory cells of the memory device 130-c. Additionally, or alternatively, the command may include an indication of a type of memory cells to write the data to.

At 320, a determination to write data may be made. For example, the memory device 130-c may determine to write data to one or more memory cells of the memory device 130-c. The one or more memory cells may include a first type of memory cells having a first storage density (e.g., TLCs). The one or more memory cells may be different than a second type of memory cells having a second storage density (e.g., SLCs). In some cases, the memory device 130-c may determine to write the data in response to receiving the command from the controller 305.

At 325, a clock rate of a channel may be adjusted (e.g., decreased or increased). For example, the memory device 130-c may adjust a clock rate associated with a clock signal in response to determining to write the data to the one or more memory cells including the first type of memory cells. For example, the clock rate of the channel may be decreased in response to the memory device 130-c changing from writing data in SLC blocks to writing data in TLC blocks. In other examples, the clock rate of the channel may be increased in response to the memory device 130-c changing from writing data in TLC blocks to writing data in SLC blocks. Such performance adjustments may be useful because the limiting parameters to data throughput may be different in different situations. For example, if writing to SLC blocks, the power consumed by the memory device 130-c may be lower than if writing to TLC blocks, but the speed with which the memory device 130-c can access the SLC blocks may be faster than the speed with which the memory device 130-c can access the TLC blocks. In such examples, the data transfer rate at the channel may be important to maintain the overall speed of the operation. Additionally, because the power used by the memory device 130-c if writing to SLC blocks than if writing to TLC blocks, there may be more power to use by the channel for transferring data (e.g., before an upper threshold of power consumption is exceeded) if the memory device 130-c is writing SLC blocks. Conversely, if writing to TLC blocks, the power consumed by the memory device 130-c may be greater than if writing to SLC blocks and the speed of the operation may be slower than writing to SLC blocks. To reduce the peak power used, the controller 305 may reduce the clock rate of the channel to reduce the power used by the channel. Thereby allowing more of the power budget to be used by the memory device 130-c before the upper threshold of power consumption is exceeded. Further, because writing to TLC blocks is slower than writing to SLC blocks, reducing the speed of the data transfer may have a relatively small impact on the overall speed of the operation. In some cases, reducing the speed of the data transfer may not affect the overall speed of the operation because accessing the TLC blocks takes longer than even the slower data transfer rate at the channel. In some cases, the clock rate (e.g., the adjusted clock rate) for the channel in response to writing data to the one or more memory cells including the first type of memory cells may be different than a respective clock rate for the channel in response to writing data to the one or more memory cells including the second type of memory cells.

At 330, a clock signal may be transmitted (e.g., output). For example, the memory device 130-c may output the clock signal at the adjusted clock rate associated with the clock signal. The clock signal may be transmitted to the controller 305. In some cases, the clock signal may be transmitted via one or more ONFI channels. In some cases, the clock signal is output in response to receiving the command (e.g., at 315). Additionally, or alternatively, the clock signal may be output in response to terminating the write boost mode. In some cases, outputting the clock signal includes generating the clock signal in accordance with the adjusted clock rate associated with the clock signal.

In some cases, a clock signal may be output in accordance with different clock rates (e.g., a first clock rate, a second clock rate, and so forth). Additionally, or alternatively, each clock rate may correspond to a respective type of memory cell (e.g., SLCs, TLCs) or a respective type of write operation (e.g., an SLC write operation, a TLC write operation). For example, the memory device 130-c may output a clock signal in accordance with a first clock rate during at least a portion of an SLC write operation and a clock signal in accordance with a second clock rate during at least a portion of a TLC write operation. In some cases, the second clock rate may be half of the first clock rate. In some cases, the clock rate may correspond to a periodicity of the clock signal. Additionally, or alternatively, an amplitude of a clock signal may be tuned (e.g., adjusted) for different types of memory cells or different types of write operations. For example, the memory device 130-c may output a clock signal with a relatively lower amplitude for TLC write operations and output a clock signal with a relatively higher amplitude for SLC write operations.

At 335, a clock signal may be transmitted. For example, the controller 305 may transmit a clock signal to the memory device 130-c. In some cases, a periodicity and amplitude of the clock signal transmitted at 335 may be the same as the clock signal transmitted at 330. In some cases, the clock signal may be transmitted via one or more ONFI channels. In some cases, the clock signal is output in response to receiving the command (e.g., at 315). Additionally, or alternatively, the clock signal may be output in response to terminating the write boost mode.

At 340, information may be transferred over the channel using the adjust clock rate. If the information is associated with a write command, the information may be transmitted by the controller 305 and received by the memory device 130-c over the channel (e.g., the ONFI channel). If the information is associated with a read command, the information may be transmitted by the memory device 130-c and received by the controller 305 over the channel (e.g., the ONFI channel).

At 345, a write operation may be performed concurrent with transferring the information. For example, the memory device 130-c may perform a write operation to write the data to the one or more memory cells of the memory system 110 the adjusted clock rate associated with the channel. In some cases, performing the write operation may include performing a garbage collection operation that includes writing the data to the one or more memory cells of the memory system 110. In some cases, the write operation is performed in response to receiving a clock signal from the controller 305.

FIG. 4 illustrates a block diagram 400 of a memory system 420 that supports managing power consumption associated with communicating data in a memory system in accordance with examples as disclosed herein. The memory system 420 may be an example of aspects of a memory system as described with reference to FIGS. 1 through 3. The memory system 420, or various components thereof, may be an example of means for performing various aspects of reducing power consumption associated with communicating data in a memory system as described herein. For example, the memory system 420 may include a data component 425, a clock component 430, a transfer component 435, a write component 440, a command component 445, a mode component 450, a garbage collection component 455, or any combination thereof. Each of these components may communicate, directly or indirectly, with one another (e.g., via one or more buses).

The memory system 420 may support operating a memory system in accordance with examples as disclosed herein. The data component 425 may be configured as or otherwise support a means for determining to write data to one or more memory cells of one or more memory devices, the one or more memory cells including a first type of memory cells having a first storage density different than a second type of memory cells having a second storage density. The clock component 430 may be configured as or otherwise support a means for adjusting a clock rate of a clock signal associated with the channel based at least in part on determining to write the data to the one or more memory cells including the first type of memory cells. The transfer component 435 may be configured as or otherwise support a means for transferring information between at least one of the one or more memory devices and a controller over the channel using the adjusted clock rate associated with the clock signal. The write component 440 may be configured as or otherwise support a means for performing, concurrently with transferring the information, a write operation to write the data to the one or more memory cells based at last in part on adjusting the clock rate associated with the channel.

In some examples, the command component 445 may be configured as or otherwise support a means for receiving a command to write the data to the one or more memory cells, where outputting the clock signal is based at least in part on receiving the command.

In some examples, the mode component 450 may be configured as or otherwise support a means for terminating a write boost mode based at least in part on determining to write the data to the one or more memory cells including the first type of memory cells, where transferring the information is based at least in part on terminating the write boost mode.

In some examples, the garbage collection component 455 may be configured as or otherwise support a means for performing a garbage collection operation including writing the data to the one or more memory cells, where transferring the information is based at least in part on the garbage collection operation.

In some examples, the clock rate associated with writing the data to the one or more memory cells including the first type of memory cells is different than a second clock rate associated with writing the data to the one or more memory cells including the second type of memory cells.

In some examples, the clock component 430 may be configured as or otherwise support a means for receiving the clock signal, where transferring the information is based at last in part on receiving the clock signal.

In some examples, the clock component 430 may be configured as or otherwise support a means for generating the clock signal in accordance with the adjusted clock rate associated with the clock signal. In some examples, the clock component 430 may be configured as or otherwise support a means for outputting the clock signal using the adjusted clock rate, where transferring the information is based at least in part on outputting the clock signal.

In some examples, the clock component 430 may be configured as or otherwise support a means for outputting, the clock signal in accordance with a first clock rate. In some examples, the write component 440 may be configured as or otherwise support a means for determining to write second data to one or more second memory cells including the second type of memory cells. In some examples, the clock component 430 may be configured as or otherwise support a means for outputting the clock signal using a second clock rate based at least in part on writing the second data to the one or more second memory cells including the second type of memory cells.

In some examples, the first clock rate is half of the second clock rate. In some examples, the clock rate corresponds to a periodicity associated with the clock signal. In some examples, the first type of memory cells includes one or more TLC memory cells, one or more MLC memory cells, one or more QLC memory cells, or any combination thereof. In some examples, the second type of memory cells includes one or more SLC memory cells.

In some examples, the clock component 430 may be configured as or otherwise support a means for transmitting, to the controller, the clock signal with a first amplitude. In some examples, the write component 440 may be configured as or otherwise support a means for determining to write second data to one or more second memory cells including the second type of memory cells. In some examples, the clock component 430 may be configured as or otherwise support a means for transmitting, to the controller, the clock signal with a second amplitude less than the first amplitude.

FIG. 5 illustrates a flowchart showing a method 500 that supports managing power consumption associated with communicating data in a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include determining to write data to one or more memory cells of a memory device (or one or more memory devices), the one or more memory cells including a first type of memory cells having a first storage density different than a second type of memory cells having a second storage density. The operations of 505 may be performed in accordance with examples as disclosed herein. In some examples, aspects of the operations of 505 may be performed by a data component 425 as described with reference to FIG. 4.

At 510, the method may include adjusting a clock rate of a clock signal associated with the channel based at least in part on determining to write the data to the one or more memory cells including the first type of memory cells. The operations of 510 may be performed in accordance with examples as disclosed herein. In some examples, aspects of the operations of 510 may be performed by a clock component 430 as described with reference to FIG. 4.

At 515, the method may include transferring information between the memory device (or one or more memory devices) and a controller over the channel using the adjusted clock rate associated with the clock signal. The operations of 515 may be performed in accordance with examples as disclosed herein. In some examples, aspects of the operations of 515 may be performed by a transfer component 435 as described with reference to FIG. 4.

At 520, the method may include performing, concurrently with transferring the information, a write operation to write the data to the one or more memory cells based at last in part on adjusting the clock rate associated with the channel. The operations of 520 may be performed in accordance with examples as disclosed herein. In some examples, aspects of the operations of 520 may be performed by a write component 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for determining to write data to one or more memory cells of a memory device or one or more memory devices, the one or more memory cells including a first type of memory cells having a first storage density different than a second type of memory cells having a second storage density; adjusting a clock rate of a clock signal associated with the channel based at least in part on determining to write the data to the one or more memory cells including the first type of memory cells; transferring information between the memory device and the controller over the channel using the adjusted clock rate associated with the clock signal; and performing, concurrently with transferring the information, a write operation to write the data to the one or more memory cells based at last in part on adjusting the clock rate associated with the channel.

Aspect 2: The method, apparatus, or non-transitory computer-readable medium of aspect 1, further including operations, features, circuitry, logic, means, or instructions, or any combination thereof for receiving a command to write the data to the one or more memory cells, where outputting the clock signal is based at least in part on receiving the command.

Aspect 3: The method, apparatus, or non-transitory computer-readable medium of any of aspects 1 through 2, further including operations, features, circuitry, logic, means, or instructions, or any combination thereof for terminating a write boost mode based at least in part on determining to write the data to the one or more memory cells including the first type of memory cells, where transferring the information is based at least in part on terminating the write boost mode.

Aspect 4: The method, apparatus, or non-transitory computer-readable medium of any of aspects 1 through 3, further including operations, features, circuitry, logic, means, or instructions, or any combination thereof for performing a garbage collection operation including writing the data to the one or more memory cells, where transferring the information is based at least in part on the garbage collection operation.

Aspect 5: The method, apparatus, or non-transitory computer-readable medium of any of aspects 1 through 4, where the clock rate associated with writing the data to the one or more memory cells including the first type of memory cells is different than a second clock rate associated with writing the data to the one or more memory cells including the second type of memory cells.

Aspect 6: The method, apparatus, or non-transitory computer-readable medium of any of aspects 1 through 5, further including operations, features, circuitry, logic, means, or instructions, or any combination thereof for receiving the clock signal, where transferring the information is based at last in part on receiving the clock signal.

Aspect 7: The method, apparatus, or non-transitory computer-readable medium of any of aspects 1 through 6, further including operations, features, circuitry, logic, means, or instructions, or any combination thereof for generating the clock signal in accordance with the adjusted clock rate associated with the clock signal and outputting the clock signal using the adjusted clock rate, where transferring the information is based at least in part on outputting the clock signal.

Aspect 8: The method, apparatus, or non-transitory computer-readable medium of any of aspects 1 through 7, further including operations, features, circuitry, logic, means, or instructions, or any combination thereof for outputting, the clock signal in accordance with a first clock rate; determining to write second data to one or more second memory cells including the second type of memory cells; and outputting the clock signal using a second clock rate based at least in part on writing the second data to the one or more second memory cells including the second type of memory cells.

Aspect 9: The method, apparatus, or non-transitory computer-readable medium of aspect 8, where the first clock rate is half of the second clock rate.

Aspect 10: The method, apparatus, or non-transitory computer-readable medium of any of aspects 1 through 9, where the clock rate corresponds to a periodicity associated with the clock signal.

Aspect 11: The method, apparatus, or non-transitory computer-readable medium of any of aspects 1 through 10, where the first type of memory cells includes one or more TLC memory cells, one or more MLC memory cells, one or more QLC memory cells, or any combination thereof and the second type of memory cells includes one or more SLC memory cells.

Aspect 12: The method, apparatus, or non-transitory computer-readable medium of any of aspects 1 through 11, further including operations, features, circuitry, logic, means, or instructions, or any combination thereof for transmitting, to the controller, the clock signal with a first amplitude; determining to write second data to one or more second memory cells including the second type of memory cells; and transmitting, to the controller, the clock signal with a second amplitude less than the first amplitude.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more memory devices comprising one or more memory cells, the one or more memory cells comprising a first type of memory cells having a first storage density different than a second type of memory cells having a second storage density; and
a controller coupled with the one or more memory devices using a channel and configured to cause the apparatus to:
determine to write data to the one or more memory cells comprising the first type of memory cells;
adjust a clock rate of a clock signal associated with the channel based at least in part on determining to write the data to the one or more memory cells comprising the first type of memory cells;
transfer information between at least one of the one or more memory devices and the controller over the channel using the adjusted clock rate associated with the clock signal; and
perform, concurrently with transferring the information, a write operation to write the data to the one or more memory cells based at last in part on adjusting the clock rate associated with the channel.

2. The apparatus of claim 1, wherein the controller is further configured to cause the apparatus to:
receive a command to write the data to the one or more memory cells, wherein to output the clock signal is based at least in part on receiving the command.

3. The apparatus of claim 1, wherein the controller is further configured to cause the apparatus to:
terminate a write boost mode based at least in part on determining to write the data to the one or more memory cells comprising the first type of memory cells, wherein to transfer the information is based at least in part on terminating the write boost mode.

4. The apparatus of claim 1, wherein the controller is further configured to cause the apparatus to:
perform a garbage collection operation comprising writing the data to the one or more memory cells, wherein to transfer the information is based at least in part on the garbage collection operation.

5. The apparatus of claim 1, wherein the clock rate associated with writing the data to the one or more memory cells comprising the first type of memory cells is different than a second clock rate associated with writing the data to the one or more memory cells comprising the second type of memory cells.

6. The apparatus of claim 1, wherein the controller is further configured to cause the apparatus to:
receive the clock signal, wherein to transfer the information is based at last in part on receiving the clock signal.

7. The apparatus of claim 1, wherein the controller is further configured to cause the apparatus to:
generate the clock signal in accordance with the adjusted clock rate associated with the clock signal; and
output the clock signal using the adjusted clock rate, wherein to transfer the information is based at least in part on outputting the clock signal.

8. The apparatus of claim 1, wherein the controller is further configured to cause the apparatus to:
output, the clock signal in accordance with a first clock rate;
determine to write second data to one or more second memory cells comprising the second type of memory cells; and
output the clock signal using a second clock rate based at least in part on writing the second data to the one or more second memory cells comprising the second type of memory cells.

9. The apparatus of claim 8, wherein the first clock rate is half of the second clock rate.

10. The apparatus of claim 1, wherein the clock rate corresponds to a periodicity associated with the clock signal.

11. The apparatus of claim 1, wherein:
the first type of memory cells comprises one or more triple-level cell (TLC) memory cells, one or more multi-level cell (MLC) memory cells, one or more quad-level cell (QLC) memory cells, or any combination thereof, and
the second type of memory cells comprises one or more single-level cell (SLC) memory cells.

12. The apparatus of claim 1, wherein the controller is further configured to cause the apparatus to:
transmit, to the controller, the clock signal with a first amplitude;
determine to write second data to one or more second memory cells comprising the second type of memory cells; and
transmit, to the controller, the clock signal with a second amplitude less than the first amplitude.

13. A non-transitory computer-readable medium storing code comprising instructions which, when executed by a processor of an electronic device, cause the electronic device to:
determine to write data to one or more memory cells of a memory device, the one or more memory cells comprising a first type of memory cells having a first storage density different than a second type of memory cells having a second storage density;
adjust a clock rate of a clock signal associated with a channel based at least in part on determining to write the data to the one or more memory cells comprising the first type of memory cells;
transfer information between the memory device and a controller over the channel using the adjusted clock rate associated with the clock signal; and
perform, concurrently with transferring the information, a write operation to write the data to the one or more memory cells based at last in part on adjusting the clock rate associated with the channel.

14. The non-transitory computer-readable medium of claim 13, wherein the instructions, when executed by the processor of the electronic device, further cause the electronic device to:
receive a command to write the data to the one or more memory cells, wherein to output the clock signal is based at least in part on receiving the command.

15. The non-transitory computer-readable medium of claim 13, wherein the instructions, when executed by the processor of the electronic device, further cause the electronic device to:
terminate a write boost mode based at least in part on determining to write the data to the one or more memory cells comprising the first type of memory cells, wherein to transfer the information is based at least in part on terminating the write boost mode.

16. The non-transitory computer-readable medium of claim 13, wherein the instructions to perform the write operation are executable by the processor to:
perform a garbage collection operation comprising writing the data to the one or more memory cells, wherein to transfer the information is based at least in part on the garbage collection operation.

17. The non-transitory computer-readable medium of claim 13, wherein the clock rate associated with writing the data to the one or more memory cells comprising the first type of memory cells is different than a second clock rate associated with writing the data to the one or more memory cells comprising the second type of memory cells.

18. The non-transitory computer-readable medium of claim 13, wherein the instructions, when executed by the processor of the electronic device, further cause the electronic device to:
receive the clock signal, wherein to transfer the information is based at last in part on receiving the clock signal.

19. The non-transitory computer-readable medium of claim 13, wherein the instructions, when executed by the processor of the electronic device, further cause the electronic device to:
generate the clock signal in accordance with the adjusted clock rate associated with the clock signal; and
output the clock signal using the adjusted clock rate, wherein to transfer the information is based at least in part on outputting the clock signal.

20. A method for operating a memory system, comprising:
determining to write data to one or more memory cells of a memory device, the one or more memory cells comprising a first type of memory cells having a first storage density different than a second type of memory cells having a second storage density;
adjusting a clock rate of a clock signal associated with a channel based at least in part on determining to write the data to the one or more memory cells comprising the first type of memory cells;
transferring information between the memory device and a controller over the channel using the adjusted clock rate associated with the clock signal; and
performing, concurrently with transferring the information, a write operation to write the data to the one or more memory cells based at last in part on adjusting the clock rate associated with the channel.
